(19) United States
(12) Patent Application Publication
(10) Pub. No.: US 2021/0104172 A1
(43) Pub. Date: Apr. 8, 2021

(54) TEACHING GUIDE FOR INSTRUMENTS

(71) Applicant: Nate Bartling, Captain Cook, HI (US)

(72) Inventor: Nate Bartling, Captain Cook, HI (US)

(21) Appl. No.: 16/594,377

(22) Filed: Oct. 7, 2019

(51) Int. Cl. G09B 15/00; G10D 3/00

(52) U.S. Cl. CPC G09B 15/004; G10D 3/00

(57) ABSTRACT

An exemplary method includes applying a teaching guide to a body side of a stringed instrument that is visible by a user when the stringed instrument is in use by the user. The teaching guide includes at least one tablature notation, each tablature notation corresponding to a respective chord for the stringed instrument.

### TECHNICAL FIELD

The present disclosure generally relates to teaching guides for instruments, and more particularly but not exclusively relates to stringed instruments including such teaching guides.

### BACKGROUND

Certain current approaches to aiding a user learning to play an instrument suffer from a variety of drawbacks and limitations. For example, one existing system involves the use of colored dots that are placed on the fretboard or a stringed instrument below the strings, with each color corresponding to a respective chord. Due to the fact that the dots are placed on the neck of the instrument, it is often difficult for the user to see the dots while in a standard playing position. For these reasons among others, there remains a need for further improvements in this technological field.

### SUMMARY

An exemplary method includes applying a teaching guide to a body side of a stringed instrument that is visible by a user when the stringed instrument is in use by the user. The teaching guide includes at least one tablature notation, each tablature notation corresponding to a respective chord for the stringed instrument. Further embodiments, forms, features, and aspects of the present application shall become apparent from the description and figures provided herewith.

### BRIEF DESCRIPTION OF THE FIGURES

FIG. 1 is a perspective view of a prior art guitar.

FIG. 2 is a plan view of a teaching guide according to certain embodiments.

FIG. 3 illustrates a tablature notation according to certain embodiments.

FIG. 4 is a side view of a guitar according to certain embodiments.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

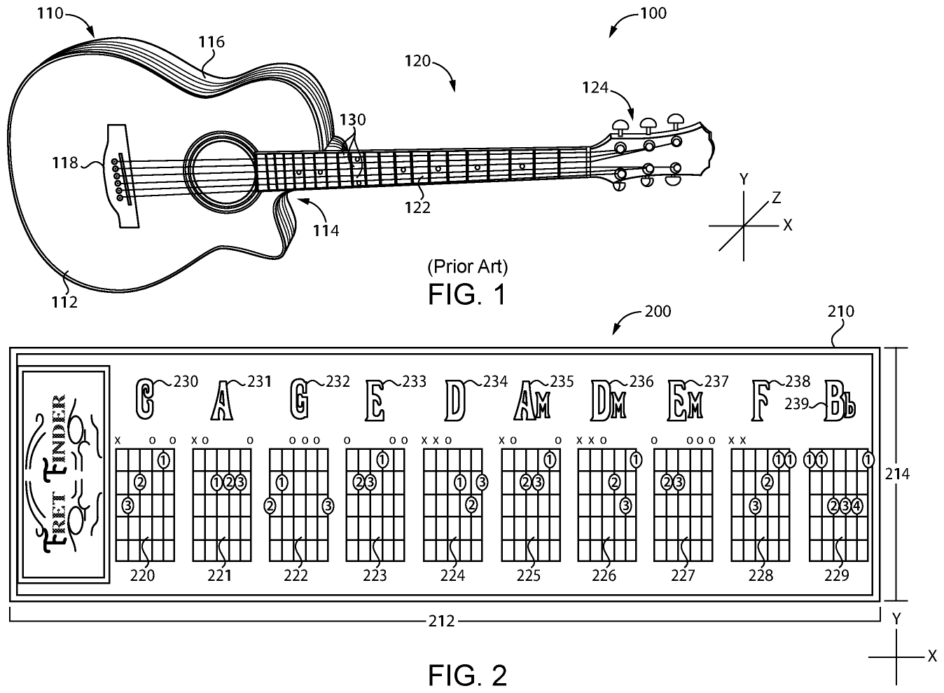

As used herein, the terms “longitudinal,” “lateral,” and “transverse” are used to denote motion or spacing along three mutually perpendicular axes, wherein each of the axes defines two opposite directions. In the coordinate system illustrated in FIG. 1, the X-axis defines first and second longitudinal directions, the Y-axis defines first and second lateral directions, and the Z-axis defines first and second transverse directions. These terms are used for ease and convenience of description, and are without regard to the orientation of the system with respect to the environment. For example, descriptions that reference a longitudinal direction may be equally applicable to a vertical direction, a horizontal direction, or an off-axis orientation with respect to the environment. Furthermore, motion or spacing along a direction defined by one of the axes need not preclude motion or spacing along a direction defined by another of the axes. For example, elements that are described as being “laterally offset” from one another may also be offset in the longitudinal and/or transverse directions, or may be aligned in the longitudinal and/or transverse directions. The terms are therefore not to be construed as limiting the scope of the subject matter described herein.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

With reference to FIG. 1, illustrated therein is a stringed instrument in the form of a guitar 100 that may be utilized in connection with certain embodiments. While the illustrated stringed instrument is provided in the form of a conventional guitar 100, it is to be appreciated that the descriptions set forth herein may be equally applicable to other forms of stringed instruments of which the side is visible while in a standard playing position, such as the ukulele. The guitar 100 generally includes a body 110, a neck 120 extending longitudinally from the body 110, and strings 130 extending along the body 110 and the neck 120.

The body 110 includes a sound board or front face 112, a bottom deck or rear face 114, a rib or body side 116 extending laterally between and connecting the front face 112 and the rear face 114, and a bridge 118 mounted to the front face 112. The neck 120 extends longitudinally from the body 110, and includes a fretboard 122 and a headstock 124 at a distal end thereof. The strings 130 extend longitudinally along the fretboard 122 from the headstock 124 to the bridge 118. The guitar 100 may be of any type known in the art, and the features thereof need not be described in further detail herein.

With additional reference to FIG. 2, illustrated therein is a teaching guide 200 according to certain embodiments. In the illustrated form, the teaching guide 200 is defined on a substrate 210, and includes one or more tablature notations 220-229 and identification indicia 230-239 corresponding to the tablature notations 220-229. As will be appreciated by those skilled in the art, each tablature notation 220-229 corresponds to a respective chord that can be played using a stringed instrument (e.g., the guitar 100), and identifies the appropriate fingering for the strings 130 to produce such a chord.

In the illustrated embodiment, the teaching guide 200 is provided on a substrate 210 that is operable to be applied to the rib or body side 116. In other embodiments, the tablature notations 220-229 and/or the identification indicia 230-239 may be directly provided to the body side 116, for example via a printing or painting process. In certain embodiments, the substrate 210 may be provided as a sticker or as a decal. In certain embodiments, the substrate 210 may be configured to be easily removed from the body 110 such that the teaching guide 200 is readily repositionable. For example, the substrate 210 may be provided as a vinyl sticker having a low-stick adhesive applied to the rear surface opposite the front surface on which the notations 220-229 and indicia 230-239 are provided. The illustrated substrate 210 has a longitudinal length 212 and a lateral width 214 that is less than the longitudinal length 212. As described herein, this arrangement facilitates mounting of the teaching guide 200 to the rib or body side 116, as well as the accommodation of the tablature notations 220-229 and identification indicia 230-239.

Each of the identification indicia 230-239 is positioned adjacent a corresponding one of the tablature notations 220-229 and indicates the chord corresponding to the respective tablature notation 220-229. For example, the tablature notation 220 indicates the fingering for the C chord, and the corresponding identification indicium 230 identifies the C chord as corresponding to the fingering indicated in the adjacent tablature notation 220. In the illustrated form, the remaining notations 221-229 and indicia 231-239 respectively correspond to the A chord (tablature notation 221 and indicium 231), the G chord (tablature notation 222 and indicium 232), the E chord (tablature notation 223 and indicium 233), the D chord (tablature notation 224 and indicium 234), the A minor chord (tablature notation 225 and indicium 235), the D minor chord (tablature notation 226 and indicium 236), the E minor chord (tablature notation 227 and indicium 237), the F chord (tablature notation 228 and indicium 238), and the B flat chord (tablature notation 229 and indicium 239). While the illustrated teaching guide 200 includes tablature notations 220-229 and identification indicia 230-239 for the ten chords illustrated in FIG. 2, it is also contemplated that the guide 200 may include more or fewer chords, and that the chords represented may be different from those specifically illustrated in FIG. 2.

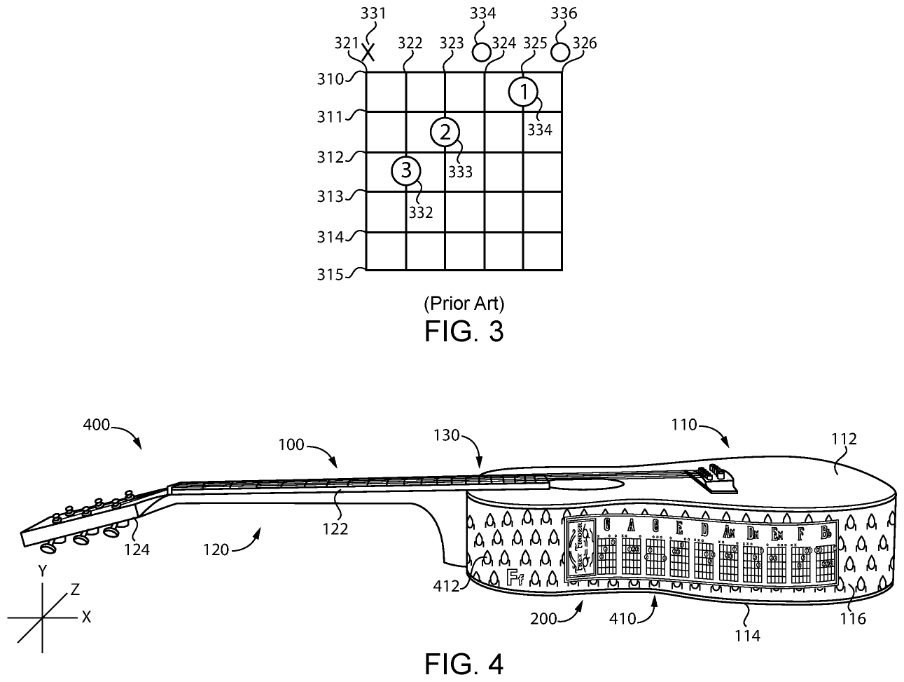

With additional reference to FIG. 3, illustrated therein is a tablature notation 300 that may be utilized in certain embodiments. The tablature notation 300 includes a plurality of horizontal fret lines 310-316 corresponding to frets of the fretboard 122, a plurality of vertical string lines 321-326 corresponding to the strings 130 of the guitar 100, and first through sixth fingering indicia 331-336 that indicate if and how each of the strings 130 should be played to produce a particular chord. The illustrated tablature notation 300 corresponds to the C-chord tablature notation 220, and identifies the fingering for the C chord. A first indicium 331 is provided as an “X” above the first string line 321, indicating that the first string is not to be strummed, and the fourth and sixth indicia 334 and 336 indicate that the fourth and sixth strings are to be played open. The remaining indicia include numbers identifying the corresponding finger and are positioned to indicate the locations on the fretboard 122 that each finger should be placed. When the user places his or her fingers in the appropriate location and strums the appropriate strings 130, the corresponding chord is produced, provided that the guitar strings 130 are properly tuned.

With additional reference to FIG. 4, illustrated therein is a guitar 400 according to certain embodiments. The guitar 400 includes the conventional guitar 100 and the teaching guide 200, which is applied to the rib or body side 116 of the conventional guitar 100. The teaching guide 200 is positioned such that when the guitar 400 is in use by a user in a standard playing position, the teaching guide 200 is visible to the player. In the illustrated form, a sticker or decal 410 defines the substrate 210 and includes the teaching guide 200 and a decorative pattern 412.

Certain embodiments of the subject application relate to a method that generally involves providing a teaching guide to a stringed instrument. For example, certain embodiments relate to applying the illustrated teaching guide 200 to an existing guitar 100 to provide the guitar 400 according to the embodiment illustrated in FIG. 4. More particularly, certain embodiments of the application relate to applying the teaching guide 200 to the body side 116 such that the teaching guide 200 is visible when the guitar 400 is being played in a standard playing position. As a result, the player can simply glance down at the teaching guide 200 while playing in order to refresh his or her memory as to the fingering of a particular chord. This is in contrast to certain existing systems, in which the user must crane his or her neck to view the fretboard 122 and correlate the colored or otherwise-labeled dots with the appropriate chord.

In certain embodiments, such as those in which the teaching guide 200 comprises a substrate 210 or is provided on a substrate 410, the method involves applying the teaching guide 200 to the guitar 100 by applying the substrate 210/410 to the body side 116. For example, in embodiments in which the substrate 210/410 is provided in the form of a sticker, the method may involve removing a protective covering from the adhesive side of the sticker, and applying the sticker to the body side 116 such that the length dimension 212 of the teaching guide 200 extends substantially along the longitudinal direction in which the neck 120 extends. The provision of a teaching guide in which the longitudinal length dimension 212 is greater than the lateral width dimension 214 may facilitate the inclusion of a greater number of chords in the teaching guide 200 while maintaining each notation at a size amenable to viewing by the player.

In other embodiments, such as those in which the teaching guide 200 does not comprise a substrate 210 and is not provided on a substrate 410, the method may involve applying the tablature notations 220-229 and/or identification indicia 230-239 directly to the body side 116. For example, the method may involve applying the tablature notations 220-229 and/or identification indicia 230-239 directly to the body side 116 via a printing or painting process. In such forms, the teaching guide 200 may again have a longitudinal length dimension 212 greater than the lateral width dimension 214 to facilitate the inclusion of a greater number of chords than may be feasible in other configurations.

In the embodiment illustrated in FIG. 2, the teaching guide 200 is provided on a substrate 210 that is generally sized and shaped to accommodate the teaching guide. In other words, the size of the teaching guide 200 generally corresponds to the size of the substrate 210. It is also contemplated that a teaching guide may be provided on a substrate 410 that is much larger than would be strictly necessary to accommodate the teaching guide. For example, the substrate 410 may be sized and shaped to wrap around substantially the entirety of the body 110 such that the substrate 410 covers the majority or the entirety of the body side 116. In addition or as an alternative to including a teaching guide 200, such a wraparound substrate 410 may include a decorative pattern 412, which may be repeating or non-repeating. For example, while FIG. 4 illustrates a sticker or decal 410 including the teaching guide 200 and a decorative pattern 412, it is contemplated that the sticker or decal 410 may include only one of the teaching guide 200 or the decorative pattern 412.

As noted above, while the illustrated embodiment relates to a guitar, it is to be appreciated that the systems and methods described herein may be utilized with other stringed instruments that include a body and a neck extending from the body, such as the ukulele. It should further be appreciated that similar concepts can be used in connection with other types of instruments. For example, a chord guide may be placed on a visible portion of a piano or another instrument to aid the player of such an instrument.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A stringed instrument, comprising:
a body including a front face, a rear face, and a body side extending between and connecting the front face and the rear face in a lateral direction;
a neck extending from the body in a longitudinal direction, the neck including a headstock;
a plurality of strings extending from a bridge mounted to the front face of the body and along the neck to the headstock; and
a teaching guide provided on the body side such that the teaching guide is visible to a user playing the stringed instrument, the teaching guide comprising at least one tablature notation, each tablature notation corresponding to a respective chord for the stringed instrument.

2. The stringed instrument of claim 1, wherein the teaching guide is removably positioned on the body side such that a position of the teaching guide is adjustable.

3. The stringed instrument of claim 1, further comprising a sticker or decal, the sticker or decal including the teaching guide.

4. The stringed instrument of claim 3, wherein the sticker or decal is elongated in the longitudinal direction such that a longitudinal length of the sticker or decal is greater than a lateral width of the sticker or decal.

5. The stringed instrument of claim 4, wherein the sticker or decal wraps around the body and covers a majority of the body side.

6. The stringed instrument of claim 5, wherein the sticker or decal further comprises a decorative pattern in locations not occupied by the teaching guide.

7. The stringed instrument of claim 1, wherein the stringed instrument is a guitar.

8. The stringed instrument of claim 1, wherein the at least one tablature notation comprises a plurality of the tablature notations, and wherein each tablature notation corresponds to a different chord.

9. The stringed instrument of claim 1, wherein the teaching guide further comprises a plurality of identification indicia, each identification indicium relating a corresponding one of the tablature notations to the respective chord for the stringed instrument.

10. A method, comprising:
applying a teaching guide to a body side of a stringed instrument that is visible by a user when the stringed instrument is in use by the user, the teaching guide comprising at least one tablature notation, each tablature notation corresponding to a respective chord for the stringed instrument.

11. The method of claim 10, wherein the teaching guide comprises a sticker including the at least one tablature notation, and wherein applying the teaching guide comprises adhering the sticker to the body side.

12. The method of claim 10, wherein when the stringed instrument is in use by the user, the body side to which the teaching guide is applied is an upper body side of the stringed instrument.

13. The method of claim 10, wherein the stringed instrument is a guitar.

14. The method of claim 10, wherein the stringed instrument comprises a body including a front face, a rear face, and the body side; and wherein the body side extends between and connects the front face and the rear face.

15. The method of claim 10, wherein the teaching guide further comprises a plurality of identification indicia, each identification indicium relating a corresponding one of the tablature notations to the respective chord for the stringed instrument.

16. The method of claim 10, wherein applying the teaching guide to the body side comprises applying a sticker or decal including the teaching guide to the body side.

17. The method of claim 16, wherein applying the sticker or decal to the body side includes wrapping the sticker or decal about a body of the stringed instrument such that the sticker or decal covers a majority of the body side.

18. The method of claim 17, wherein the sticker or decal further comprises a decorative pattern.

19. A method, comprising:
applying a sticker or decal to a stringed instrument comprising a body portion having a front face, a back face, and a body side extending between and connecting the front face and the rear face;
wherein applying the sticker or decal comprises wrapping the sticker or decal about the body such that the sticker or decal covers a majority of the body side; and
wherein the sticker or decal comprises a decorative pattern.

20. The method of claim 19, wherein the sticker or decal comprises at least one tablature notation, each tablature notation identifying a fingering arrangement for a respective chord of the stringed instrument.
